(19) United States
(12) Patent Application Publication
(10) Pub. No.: US 2004/0093661 A1
(43) Pub. Date: May 20, 2004

(54) Dispensing means and method for genital coating

(76) Inventor: Jason C. Birnholz, Highland Park, IL (US)

Correspondence Address: Charles E. Temko, 22 Marion Road, Westport, CT, 06880, US

(21) Appl. No.: 10/693,452

(22) Filed: Oct. 27, 2003

Related U.S. Application Data
(60) Provisional application No. 60/424,611, filed on Nov. 6, 2002.

(51) Int. Cl. A61J 19/00

(52) U.S. Cl. 4/279

(57) ABSTRACT

A device for evenly coating the internal surfaces of a body cavity, such as genital areas, which is at least partially insertable into the cavity, following which the device is simultaneously manually squeezed while rotating the device to cause dispensing of the coating in an even spiral path as the device is slowly withdrawn from the cavity. In one embodiment, the device is a blow-molded capsule having a neck portion from which a laterally-extending hollow tube projects. In the second embodiment the device is somewhat larger with the medicament container being of rigid cylindrical configuration, and is provided with a manually operable pump having a laterally-extending orifice.

### RELATED APPLICATION

Reference is made to my copending provisional application, Serial No. 60/424,611, filed Oct. 1, 2002, to which a claim of priority is made.

### BACKGROUND OF THE INVENTION

This invention relates generally to the field of medicinal coatings, and more particularly to improved means for applying such coatings to human genital areas for the purpose of sensitizing the surfaces thereof.

Coatings of this type are well-known in the art, many employing as an active ingredient such compositions as benzalkonium chloride, and more recently polysiloxanes. They can be in the form of a water-based gel or liquids of oil-like consistency, which are too viscous to apply as a spray.

Such compositions are not easily applied without soiling the hands or at least the fingers of users, and there arises a need for dispensing and applying means in a convenient manner without the necessity of subsequently washing the hands.

### SUMMARY OF THE INVENTION

Briefly stated, the invention contemplates the provision of a means and method for applying sensitizing coatings in a convenient manner. In a first embodiment, a quantity of material is encased in a synthetic resinous flexible capsule having a narrow portion at one end thereof terminating in a laterally-extending tube having a closed terminal which may be manually torn or otherwise severed so that the capsule may be at least partially inserted and simultaneously rotated and squeezed as it is withdrawn to effect a dispensing action of the contents and spreading without the necessity of soiling the fingers of the user.

In a second embodiment, the medicament is stored in a bottle-like container of relatively small dimensions, an upper end of which is provided with a finger-activated pump having a laterally-extending nozzle wherein the nozzle may be inserted and the pump actuated using an index finger disposed opposite the nozzle. As the pump is activated, the nozzle is rotated to provide an equivalent result. This embodiment may be reused many times until the contents of the container are consumed.

### BRIEF DESCRIPTION OF THE DRAWINGS

In the drawings, to which reference will be made in the specification, similar reference characters have been employed to designate corresponding parts throughout the several views.

FIG. 1 is a side elevational view of a first embodiment of the invention.

FIG. 2 is a side elevational view of a second embodiment of the invention.

### DETAILED DESCRIPTION OF THE DISCLOSED EMBODIMENTS

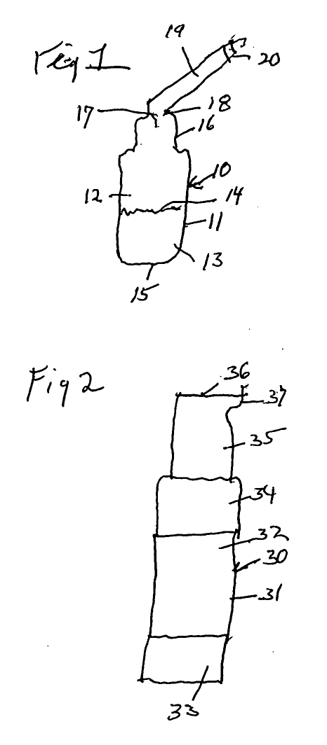

With reference to FIG. 1 in the drawing, a first embodiment, generally indicated by reference character 10 comprises a blow-molded capsule or container 11 having a flexible main body 12 defining a cavity 13 for reception of fluid contents 14. A first end 15 is of spherical configuration, while a second end 16 tapers to form a neck 17 of smaller diameter, a free end 18 communicating with a laterally-extending tube 19 having a free end 20 closed by heat-sealing or suitable crimping. The first embodiment is conveniently used by tearing or cutting the closed free end to provide a continuous passage, following which the capsule may be inserted in the body cavity, and using the thumb and forefinger, the capsule may be simultaneously squeezed and rotated as it is slowly withdrawn to result in a dispensing of the medicament in an arcuate spiral upon the walls of the cavity. Normally, the entire contents will be dispensed during this action, following which the capsule may be discarded.

In the second embodiment (FIG. 2) generally indicated by reference character 30, there is provided a multiple use container including a generally cylindrical body 31 in which an upper portion 32 forms the actual container for the medicament, while a lower portion 33 provides length. An upper threaded housing 34 engages a small manually-operated pump 35, an upper end 36 of which includes a laterally-extending nozzle 37 through which the contents are dispensed.

The use of this embodiment differs somewhat from that of the first embodiment. The body 31 is grasped between the thumb and middle finger, whereby the index finger may be positioned opposite the nozzle 37 and flexed to operate the pump 35, as the body 31 is rotated and withdrawn. Since rotation requires wrist rotation, complete coating requires separate manipulation covering areas of approximately 120 degrees each. As is the case with the first embodiment, it is not necessary to soil the fingers of the users.

It may thus be seen that I have invented novel and highly useful improvements in dispensers for applying a medicament to internal genital areas, in which it is possible to apply the medicament in a thin coating without the necessity of soiling the fingers of the user. In a first embodiment, the device is disposable after a single use, and is of relatively small overall dimensions so as to be literally portable in a personal handbag. In a second embodiment, the device may be used in a generally similar manner, and is in the form of an elongated container which is partially insertable into the body cavity for dispensing the contents thereof.

I wish it to be understood that I do not consider the invention to be limited to the precise details of structure shown and described in the specification, for obvious modifications will occur to those skilled in the art to which the invention pertains.

I claim:

1. A device for applying a fluid medicament to internal genital areas comprising: a hollow elongated flexible body forming a cavity for containing said medicament, said body having an end portion thereof forming an open neck portion, a hollow tube interconnected to said neck having a selectively sealed terminal, said tube extending laterally of said neck, whereby with manual rotation of said body and simultaneously applied pressure, said medicament may be dispensed over a continuous arcuate path.

2. A device in accordance with claim 1, said device being blow-molded from synthetic resinous materials.

3. A device for dispensing a medicament over the surface of an internal body cavity comprising: a generally cylindrical hollow main body for containing said medicament, said body having an open upper end; a manually-operated pump communicating with said body, said pump including a manually-reciprocating member having a laterally-oriented nozzle, at least a portion of said device being insertable into said cavity following which operation of said pump causes dispensing of said medicament over a laterally-directed path.

4. The method of applying a medicament to the surface of a body cavity comprising the steps of:
a) providing a container for said medicament having a laterally-oriented nozzle, and integral means for expelling said medicament through said nozzle;
b) inserting said nozzle into said cavity;
c) and operating said device for expelling said medicament while simultaneously rotating said nozzle through an arcuate path of movement to evenly coat said surface.
